(19) United States
(12) Patent Application Publication
(10) Pub. No.: US 2024/0297940 A1
(43) Pub. Date: Sep. 5, 2024

(54) PROCESSING DEVICE, PROCESSING METHOD, AND STORAGE MEDIUM

(71) Applicant: CANON KABUSHIKI KAISHA, Tokyo (JP)

(72) Inventor: SATOSHI TOTSUKA, Ibaraki (JP)

(21) Appl. No.: 18/585,717

(22) Filed: Feb. 23, 2024

(30) Foreign Application Priority Data
Mar. 3, 2023 (JP) 2023-032854

(51) Int. Cl. H04N 1/00

(52) U.S. Cl. CPC H04N 1/00005; H04N 1/00724; H04N 1/00734; H04N 1/00779

(57) ABSTRACT

An image forming apparatus determines the type of paper on the basis of the feature value (the basis weight, the surface property, and the like) of the paper detected by the media sensor and sets, as information to be registered in a paper database, a print control parameter for the paper on the basis of the detected type of paper. The image forming apparatus further sets a print control parameter for paper on which an adjustment chart is printed on the basis of the adjustment chart detected by an image reading unit.

### BACKGROUND

### Field of the Disclosure

The present disclosure relates to a processing device, a processing method, and a storage medium.

### Description of the Related Art

Some image forming apparatuses include a paper type detection sensor (a media sensor) that measures the feature value of a sheet, such as the surface property and basis weight of paper, in a sheet conveying path. The image forming apparatuses measure the feature value of a sheet fed on the basis of a print job with a media sensor and identifies the paper type by using a pre-stored paper database (a media library) on the basis of the measured feature value of the paper. The image forming apparatuses then print on the sheet by using print control parameters corresponding to the identified paper type.

Japanese Patent Laid-Open No. 2022-26815 describes a technique for printing on a wide variety of types of paper using print control parameters as well as the basic types (the default types) of paper. The image forming apparatus described in Japanese Patent Laid-Open No. 2022-26815 duplicates the print control parameters for a sheet of a basic paper type prepared in advance, and a user changes the duplicated print control parameters to set the print control parameters for a user define sheet (a paper type set uniquely by the user). In the image forming apparatus described in Japanese Patent Laid-Open No. 2022-26815, a user-defined medium is created by measuring and identifying the basic paper type that serves as a duplication source for a user define sheet with a media sensor and causing the user to set the print control parameters for the basic paper information.

However, with the technology discussed above, when registering paper information in the paper database, the user needs to manually set the print control parameters even if the print control parameters are identified by measurement. This puts a burden on the user to set the print control parameters.

### SUMMARY

Accordingly, aspects of the present disclosure reduce the burden on the user when registering paper information in the paper database.

According to an aspect of the present disclosure, a processing device includes a detection unit configured to detect, from paper, paper information that reflects a feature of the paper and a setting unit configured to set at least one of a plurality of print control parameters that are used to print on the paper as information to be registered in a paper database, based on the paper information detected by the detection unit.

Further features of the present disclosure will become apparent from the following description of embodiments with reference to the attached drawings.

### BRIEF DESCRIPTION OF THE DRAWINGS

FIG. 1 is a schematic illustration of the configuration of an image forming apparatus.

FIG. 2 illustrates the internal configuration of the image forming apparatus.

FIG. 3 illustrates the configuration of a fixing unit.

FIG. 4 illustrates the configuration of a media sensor.

FIGS. 5A and 5B illustrate paper type selection screens.

FIGS. 5C to 5E illustrate screens that are displayed after an operation on the paper type selection screen is completed.

FIGS. 6A and 6B illustrate screens used to register a user define sheet.

FIGS. 6C and 6D illustrate screens that are displayed following the screen illustrated in FIG. 6B.

FIGS. 6E and 6F illustrate screens that are displayed following the screen illustrated in FIG. 6D.

FIG. 7 is a flowchart of the process performed when a user define sheet is registered.

### DESCRIPTION OF THE EMBODIMENTS

An embodiment of the present disclosure is described below with reference to the accompanying drawings. The embodiment described below is only an example, and the present disclosure is not limited to the embodiment described below. In the embodiment described below, the same reference numeral is used to identify the same configuration, and detailed description of the configuration is omitted.

### Configuration of Image Forming Apparatus

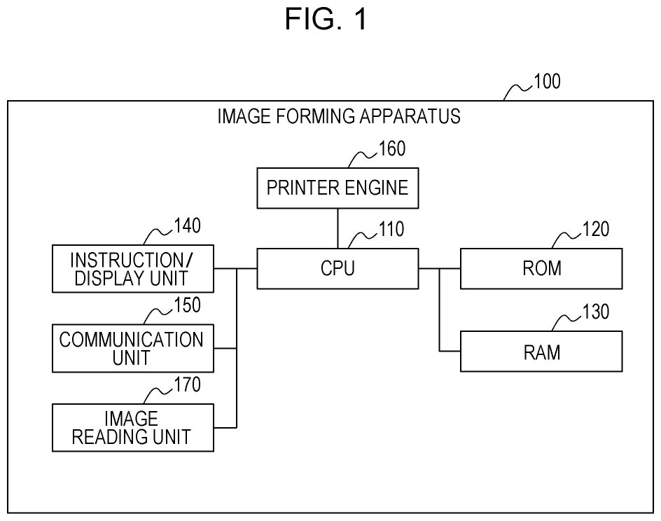

FIG. 1 schematically illustrates an example of the configuration of an image forming apparatus 100. In FIG. 1, a central processing unit (CPU) 110 is an example of a control unit that performs overall control of the image forming apparatus 100. The image forming apparatus 100 may have one or more dedicated hardware units different than the CPU 110, and the dedicated hardware units may perform at least some of the processes to be performed by the CPU 110. The dedicated hardware unit is, for example, an ASIC (application-specific integrated circuit), an FPGA (field programmable gate array), or a DSP (digital signal processor). The image forming apparatus 100 may have a hardware processor other than a CPU (for example, a GPU) instead of or in addition to the CPU 110.

A read only memory (ROM) 120 stores, for example, a control program and initial values of various setting values according to the present embodiment. The CPU 110 executes the control program according to the present embodiment fetched from the ROM 120 to perform the procedures for image formation and each of the steps of a flowchart described below. A random access memory (RAM) 130 stores a variety of types of information under the control of the CPU 110. The present embodiment is described with reference to, as an example, the case in which a paper type database (also referred to as a “paper database” or “media library”) is stored in the RAM 130, and the paper type database stores paper information, such as a paper name (type name), size, and print control parameters, for each of the paper types. It is desirable that the RAM 130 be a rewritable memory that does not require an information refresh operation. When a user changes print control parameters corresponding to a certain paper type, the CPU 110 adds (stores) the changed print control parameters to the paper type database as the print control parameters corresponding to the paper type. The print control parameters are print control parameters set uniquely by the user.

The instruction/display unit 140 has the function of displaying various types of information and the function of a user interface. The instruction/display unit 140 includes a display (for example, a touch panel) capable of displaying an operation screen, buttons, and the like. When a user inputs an instruction to start a printing operation or the like by operating, for example, the button provided on the instruction/display unit 140, the instruction/display unit 140 outputs instruction information indicating the details of the instruction to the CPU 110. However, for the user to input the instruction information for starting, for example, the printing operation to the image forming apparatus 100, it is not only way to operate the instruction/display unit 140 to input the information to the image forming apparatus 100. For example, the instruction information for starting the printing operation may be input to the image forming apparatus 100 from an external device (for example, a personal computer, a tablet, or a smartphone) connected via a network or the like (not illustrated).

The communication unit 150 includes a hardware interface for the image forming apparatus 100 to communicate with the external device.

The printer engine 160 performs a variety of operations to form an image on paper (that is, performs a printing operation) on the basis of instructions from the CPU 110. For example, when the instruction information to start a printing operation is input, the CPU 110 drives and controls a feed-conveyance motor of the printer engine 160 in accordance with the instruction information. The printer engine 160 conveys paper placed in a sheet feeding unit. The CPU 110 also controls the formation (printing) of an image by the printer engine 160 by setting print control parameters for the printer engine 160. The printer engine 160 prints on the paper on the basis of the print control parameters set by the CPU 110.

An image reading unit 170 optically reads the information printed on the paper and converts the information into image data (digital data). The image reading unit 170 includes an image scanner. The CPU 110 performs a process to print, on paper, the image based on the image data obtained by the image reading unit 170.

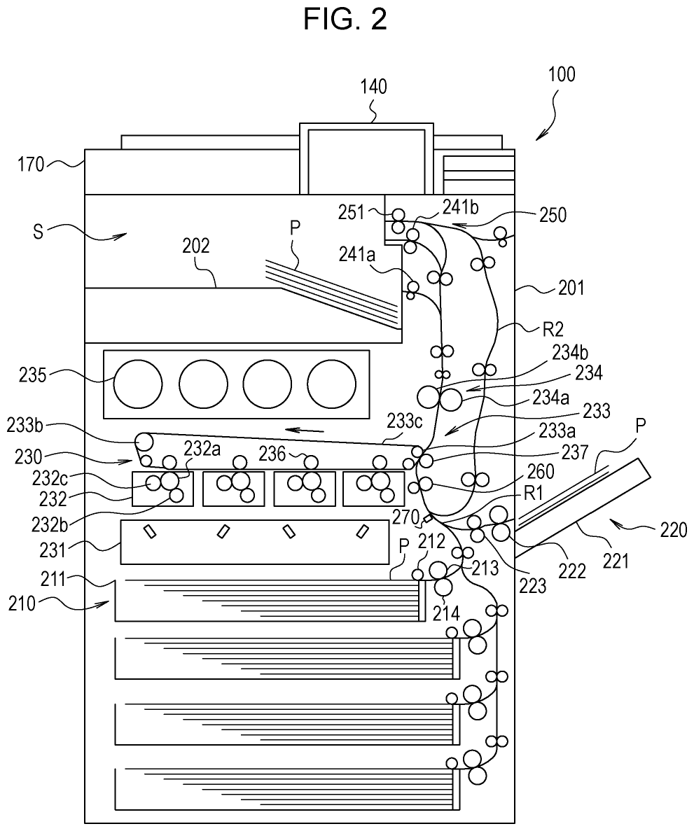

FIG. 2 illustrates an example of the internal configuration of the image forming apparatus 100.

In FIG. 2, the image reading unit 170 is mounted horizontally on top of an image forming apparatus main body 201. An output space S to which printed paper P is output is formed between the image reading unit 170 and the image forming apparatus main body 201. The printed paper P is stacked onto a stacking unit 202 protruding from the bottom of the output space S. The configuration in the image forming apparatus main body 201 illustrated in FIG. 2 is included in the printer engine 160 illustrated in FIG. 1, except for the paper P.

A cassette sheet feeding unit 210 feeds the paper P from a feed cassette 211. The cassette sheet feeding unit 210 includes a pickup roller 212, a feed roller 213, and a retard roller 214. For convenience of notation, only one cassette sheet feeding unit 210 has a reference numeral in FIG. 1. The pickup roller 212 feeds the paper P from the feed cassette 211. The feed roller 213 and the retard roller 214 are rollers for separating the paper P fed from the pickup roller 212 and conveying the paper P to a sheet conveying path R1.

A manual feeding unit 220 conveys the paper P from a manual feed tray 221. The manual feeding unit 220 includes a feed roller 222 and a pull-out roller 223. Like the cassette sheet feeding unit 210, the manual feeding unit 220 delivers the paper P from the manual feed tray 221 to the sheet conveying path R1, separates the delivered paper P, and conveys the paper P to the sheet conveying path R1.

A registration roller pair 260 is provided in the sheet conveying path R1 between each of the cassette sheet feeding unit 210 and the manual feeding unit 220 and an image forming unit 230. The registration roller pair 260 corrects the skew of the paper P (that is, travelling of the paper P at an angle to the extension direction of the sheet conveying path R1).

The image forming unit 230 is, for example, a four-drum full-color unit. The image forming unit 230 includes, for example, a laser scanner 231 and four process cartridges 232 to form a toner image in four colors (that is, yellow (Y), magenta (M), cyan (C), and black (K)). For convenience of notation, only one color (for example, yellow) process cartridge 232 has a reference numeral in FIG. 1.

Each of the process cartridges 232 includes a photoconductor drum 232a, a charger 232b serving as a charging unit, and a developing device 232c serving as a developing unit. The image forming unit 230 further includes a secondary transfer unit 233 and a fixing unit 234 provided above the process cartridge 232. A toner cartridge 235 is a cartridge for supplying toner to the developing device 232c.

The secondary transfer unit 233 includes a drive roller 233a, a tension roller 233b, and a transfer belt 233c. The transfer belt 233c is wound around the drive roller 233a and the tension roller 233b. A primary transfer roller 236 is provided inside of the transfer belt 233c. The primary transfer roller 236 is in contact with the transfer belt 233c at a position facing the photoconductor drum 232a. For convenience of notation, only one primary transfer roller 236 has a reference numeral in FIG. 1.

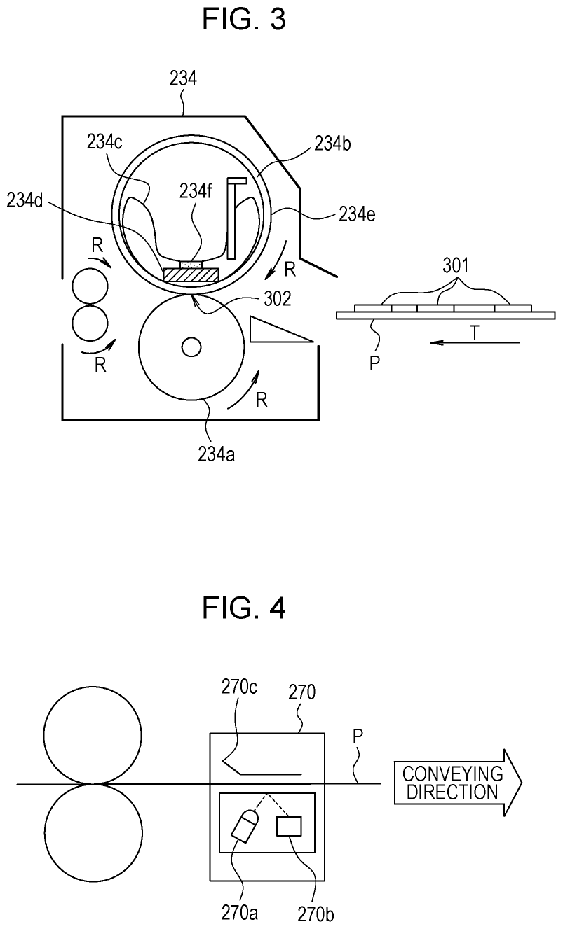

The transfer belt 233c is rotated in the direction of the arrow by the drive roller 233a, which is driven by a drive unit (not illustrated). A secondary transfer roller 237 is provided in the secondary transfer unit 233 at a position facing the drive roller 233a. The secondary transfer roller 237 transfers a color image formed on the transfer belt 233c onto the paper P. The fixing unit 234 is provided above the secondary transfer roller 237. The fixing unit 234 includes a pressure roller 234a and a heat roller 234b. An example configuration of the fixing unit 234 is described in detail below with reference to FIG. 3.

A first discharge roller pair 241a, a second discharge roller pair 241b, and a duplex printing reversing unit 250 are provided at the upper left of the fixing unit 234. The duplex printing reversing unit 250 includes a reversing roller pair 251 that is capable of both forward and reverse rotation. The paper P having an image formed on one side is delivered by the reversing roller pair 251 to a re-conveying path R2 and is conveyed again to the image forming unit 230.

A display of the instruction/display unit 140 is provided on top of the image forming apparatus 100.

A media sensor 270 detects the feature value of the paper P from the paper P that is being conveyed from the sheet feeding unit along the sheet conveying path R1. The feature value of paper is, for example, the surface property (the characteristics of the surface shape), the thickness, and the size. An example of the media sensor 270 is described in detail below with reference to FIG. 4.

While the internal configuration of the image forming apparatus 100 according to the present embodiment has been described above, the internal configuration of the image forming apparatus 100 described above is only an example, and the internal configuration is not limited thereto.

### Operation Performed by Image Forming Apparatus

An example of the operation performed by the image forming apparatus 100 that forms an image on the paper P is described below. Upon receiving image data of a document to be printed, the CPU 110 performs image processing on the image data first. The CPU 110 converts the processed image data into electrical signals and transmits the electrical signals to the laser scanner 231 of the image forming unit 230. The surface of the photoconductor drum 232a that is uniformly charged to a potential of a predetermined polarity by the charger 232b is sequentially exposed by a laser beam output from the laser scanner 231. As a result, yellow, magenta, cyan, and black electrostatic latent images are sequentially formed on the photoconductor drums 232a of the process cartridges 232.

Thereafter, the electrostatic latent images are visualized by being developed using toner of the colors. The toner images of the colors on the corresponding photoconductor drums 232a are sequentially transferred to the transfer belt 233c in a superimposed manner by primary transfer biases applied to the primary transfer rollers 236. As a result, a toner image is formed on the transfer belt 233c. Simultaneously with the toner image forming operation, the paper P is conveyed one by one to the registration roller pair 260 by the cassette sheet feeding unit 210 or the manual feeding unit 220. The skew of paper P is corrected by the registration roller pair 260. The paper P is then conveyed to the secondary transfer unit 233 by the registration roller pair 260. A secondary transfer bias is applied to the secondary transfer roller 237. As a result, the toner images formed on the transfer belt 233c are transferred to the paper P conveyed to the secondary transfer unit 233 in a single instance. The paper P having the toner image transferred thereon is conveyed to the fixing unit 234.

The paper P conveyed to the fixing unit 234 is subjected to heat and pressure in a roller nip section formed by the pressure roller 234a and the heat roller 234b. This melts the toner of each color on the paper P, causing the colors to mix and fixing a color image on the paper P. At this time, the adhesive force of the melted toner may cause the paper P to generate a sticking force to the heat roller 234b. If the stiffness (flexural rigidity) of the paper P is low, the paper P may be wound around the rotating heat roller 234b. For this reason, a separation plate (not illustrated) is provided downstream of the heat roller 234b to separate the paper P from the heat roller 234b. Thereafter, the paper P having the image fixed thereon is output into the output space S by a first discharge roller pair 241a and a second discharge roller pair 241b provided downstream of the fixing unit 234. The paper P discharged into the output space S is stacked onto the stacking unit 202 that protrudes from the bottom of the output space S. When images are formed on both sides of the paper P, the paper P is conveyed to the re-conveying path R2 by the reversing roller pair 251 after the image is fixed on one side (a front side) of the paper P. The paper P having the image formed on one side (the front side) is conveyed to the image forming unit 230 through the re-conveying path R2. Subsequently, an image is formed on the back side of the paper P in the same manner as described above.

The media sensor 270 is provided in the sheet conveying path R1. As described above, the present embodiment is described with reference to, as an example, the case in which the media sensor 270 detects the feature value of the paper P being conveyed along the sheet conveying path R1 from each of the feed cassette 211 and the manual feed tray 221 to the image forming unit 230. In addition, the present embodiment is described with reference to, as an example, the case in which the CPU 110 determines the type of the paper P on the basis of the feature value of the paper P detected by the media sensor 270.

The installation location of the media sensor 270 is not limited to the location illustrated in FIG. 1. For example, to detect the feature value of the paper P conveyed from the manual feed tray 221, the media sensor 270 may detect the feature value of the paper P being conveyed along the sheet conveying path R1 between the feed roller 222 and the pull-out roller 223, for example. In this case, the media sensor 270 detects the feature value of the paper P conveyed from the manual feed tray 221 and does not detect the feature value of the paper P conveyed from the feed cassette 211. Alternatively, for example, to detect the feature value of paper P conveyed from feed cassette 211, the media sensor 270 may detect the feature value of paper P being conveyed at, for example, the position where the sheet conveying paths R1 from the feed cassettes 211 to the image forming unit 230 join together. Still alternatively, the media sensor 270 may detect the feature value of the paper P being conveyed along, for example, the paper conveying path R1 downstream of the image forming unit 230.

According to the present embodiment, determination of the paper type by the CPU 110 on the basis of the result of detection of the feature value of paper by the media sensor 270 is also expressed as determination of the paper type by using the media sensor 270 as appropriate.

While the basic operation performed by the image forming apparatus 100 according to the present embodiment has been described above, the above-described basic operation performed by the image forming apparatus 100 is only an example, and the basic operation is not limited thereto.

### Description of Fixing Unit

FIG. 3 illustrates an example of the configuration of the fixing unit 234. The present embodiment is described with reference to the case in which, for example, the fixing unit 234 is an assembly. As described above, the fixing unit 234 includes the pressure roller 234a and the heat roller 234b. The fixing unit 234 further includes a heater holder 234c, a fixing heater 234d, a fixing film 234e, and a temperature detection sensor 234f.

The heater holder 234c holds (fixes) the fixing heater 234d. The fixing heater 234d is fixed to the lower part of the heater holder 234c. The longitudinal direction of the fixing heater 234d (a direction perpendicular to the plane of FIG. 3) is parallel to the longitudinal direction of the heater holder 234c (the direction perpendicular to the plane of FIG. 3), for example. The fixing film 234e is an elastic layer and is provided on a surface of the heat roller 234b. The arrows R illustrated in FIG. 3 indicate the directions of rotation of the pressure roller 234a and the heat roller 234b. The arrow T illustrated in FIG. 3 indicates the movement direction of the paper P having the toner 301 placed thereon.

Both ends of the core of the pressure roller 234a (the ends in the direction perpendicular to the plane of FIG. 3) are journaled for free rotation in both end portions of the fixing unit 234 (the end portions in the direction perpendicular to the plane of FIG. 3). The heater holder 234c is installed with the side adjacent to the fixing heater 234d in contact with the heat roller 234b. In addition, the heater holder 234c is being pressed with a predetermined pressure by a pressing mechanism (not illustrated). As a result, the surface of the fixing heater 234d is in tight contact with the pressure roller 234a across the fixing film 234e against the elasticity of the pressure roller 234a to form a roller nip section 302 having a predetermined width.

The pressure roller 234a is driven by a drive mechanism (not illustrated) to rotate at a predetermined peripheral speed in a counterclockwise direction as indicated by the arrow R. The fixing heater 234d includes a ceramic substrate and a resistance heating element provided on the ceramic substrate. The temperature detection sensor 234f is in contact with the fixing heater 234d. The CPU 110 controls the electric power supplied to the fixing heater 234d on the basis of the temperature of the fixing heater 234d detected by the temperature detection sensor 234f so that the temperature of the fixing heater 234d is maintained at a predetermined target temperature. The target temperature of the fixing heater 234d is determined in accordance with the type of paper, the ambient temperature, and the like. The CPU 110 determines the target temperature of the fixing heater 234d in accordance with the type of paper set by the instruction/display unit 140 or detected by the media sensor 270. For example, the target temperature of the fixing heater 234d is set to a lower temperature for thin paper and a higher temperature for thick paper than for plain paper.

While the configuration of the fixing unit 234 according to the present embodiment has been described above, the above-described fixing unit 234 is an only example, and the fixing unit 234 is not limited thereto.

### Description of Media Sensor

FIG. 4 illustrates an example of the configuration of the media sensor 270. In the example illustrated in FIG. 4, the media sensor 270 includes a light emitting element 270a and a light receiving element 270b. The light emitting element 270a is, for example, a light emitting diode (LED). The light receiving element 270b is, for example, a photodiode.

The light emitting element 270a and the light receiving element 270b are installed so that the light receiving element 270b can detect the light emitted by the light emitting element 270a and reflected by the paper P. The light receiving element 270b detects the amount of light reflected by the paper P. The media sensor 270 further includes a guide unit 270c that guides the paper P to the conveying path inside of the media sensor 270.

The CPU 110 receives an input signal from the light receiving element 270b as the output value of the media sensor 270. The output value of the media sensor 270 varies in accordance with the feature value of the paper (for example, the surface property and the basis weight). The CPU 110 can identify the feature value of the paper P on the basis of the output value of the media sensor 270 and can determine the type of the paper P on the basis of the identified feature value. For example, the CPU 110 determines the type of the paper P using a paper type database that stores the type of paper and the feature value of the paper associated with each other. In this case, the CPU 110 determines the type of the paper P by identifying the feature value of the paper P on the basis of the output value of the media sensor 270 and retrieving, from the paper type database, the type of paper associated with the identified feature value. If the type of paper associated with the feature value of the paper P is not found in the paper type database, the CPU 110 determines that the paper P is paper that cannot be printed. In this case, the CPU 110 may cause the instruction/display unit 140 to display a message stating that the paper P is not suitable for printing and, therefore, cannot be printed. For an adjustment chart described below, the CPU 110 determines that printing is performed even if the paper type associated with the feature value of the paper P is not found in the paper type database.

Thereafter, the CPU 110 optimally controls the image forming speed and the target temperature of the fixing unit 234 (the fixing heater 234d) in accordance with the determined type of the paper P. As described above, according to the present embodiment, the CPU 110 determines the type of the paper P using the media sensor 270, so that the user need not set the type of paper consciously. Therefore, the image forming apparatus 100 according to the present embodiment has a mode in which the type of paper is determined using the media sensor 270 and the print control parameters and the like are automatically set in accordance with the type of paper (hereinafter, the mode is referred to as a “media auto-setting mode”). In addition, the image forming apparatus 100 according to the present embodiment has a mode in which the user manually sets the type of paper to be used for printing (hereinafter, the mode is referred to as a “media manual setting mode”).

The user can preset one of the media auto-setting mode and the media manual setting mode for each of the feed cassettes 211 and the manual feed tray 221 by operating the instruction/display unit 140. The default mode is, for example, the media auto-setting mode. A setting value indicating which one of the media auto-setting mode and the media manual setting mode is selected as the setting mode is stored in the RAM 130, for example.

While the configuration of the media sensor 270 according to the present embodiment has been described above, the above-described configuration of the media sensor 270 is only an example, and the configuration is not limited thereto. For example, the media sensor 270 may have a configuration obtained by combining an ultrasonic sensor, such as a piezoelectric element, with the light emitting element and the light receiving element and may have the configuration.

The method for setting one of the media auto-setting mode and the media manual setting mode and the processing performed by the image forming apparatus 100 in accordance with the setting are performed in the way described in Japanese Patent Laid-Open No. 2022-26815, for example. Therefore, a detailed description of the same part as described in Japanese Patent Laid-Open No. 2022-26815 is omitted here. When the setting mode is the media auto-setting mode, the image forming apparatus 100 according to the present embodiment uses the media sensor 270 to determine the type of paper to be used for printing. In contrast, when the setting mode is the media manual setting mode, the image forming apparatus 100 uses the type of paper that is manually set by the user for printing.

### Description of User Define Sheet

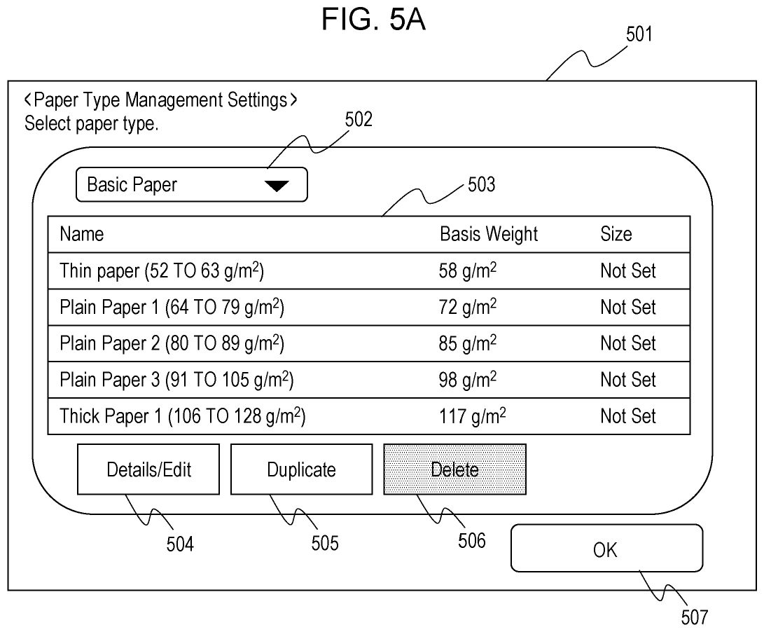

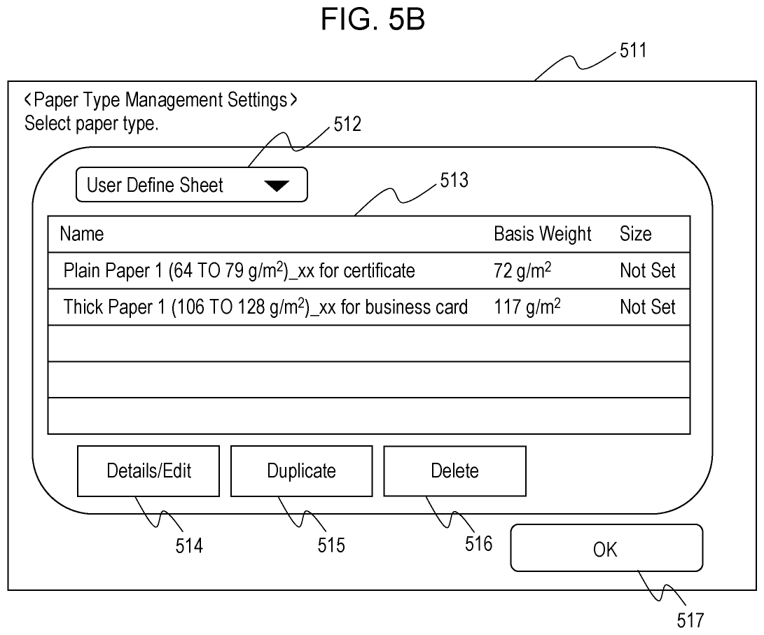

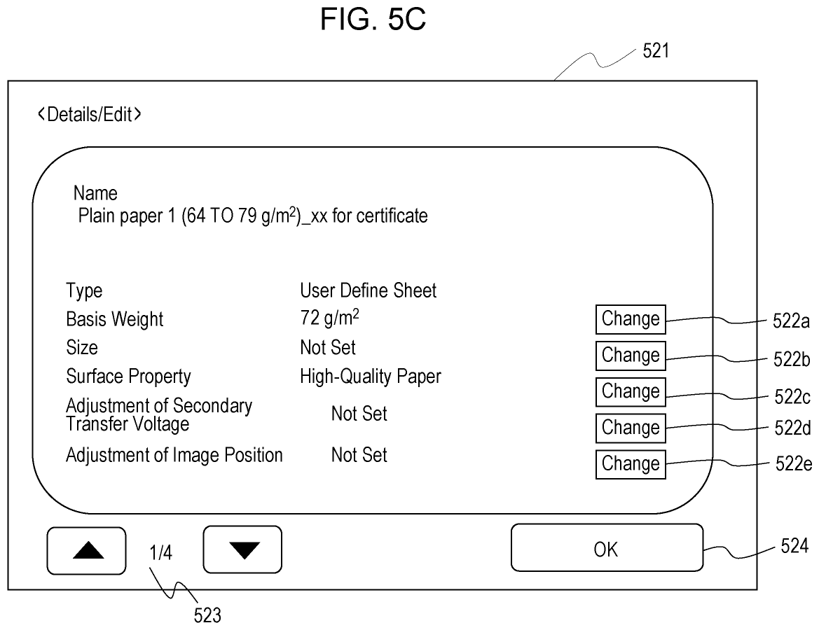

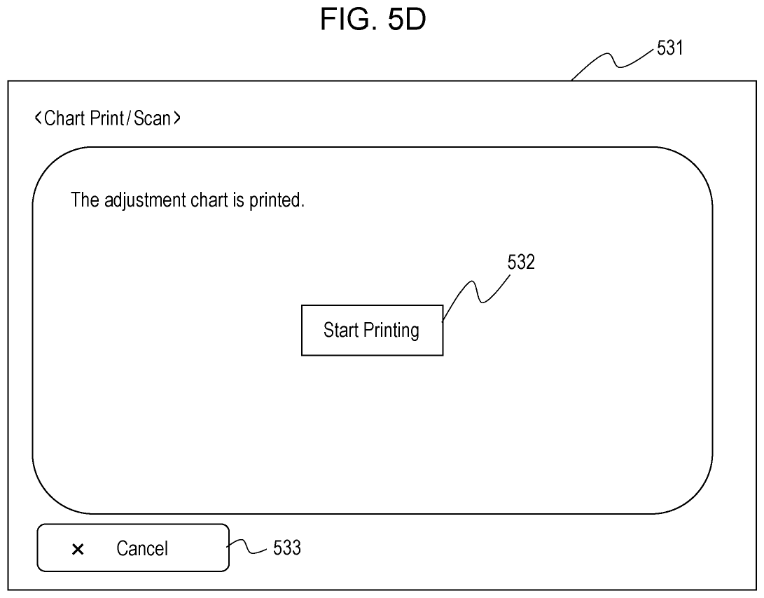

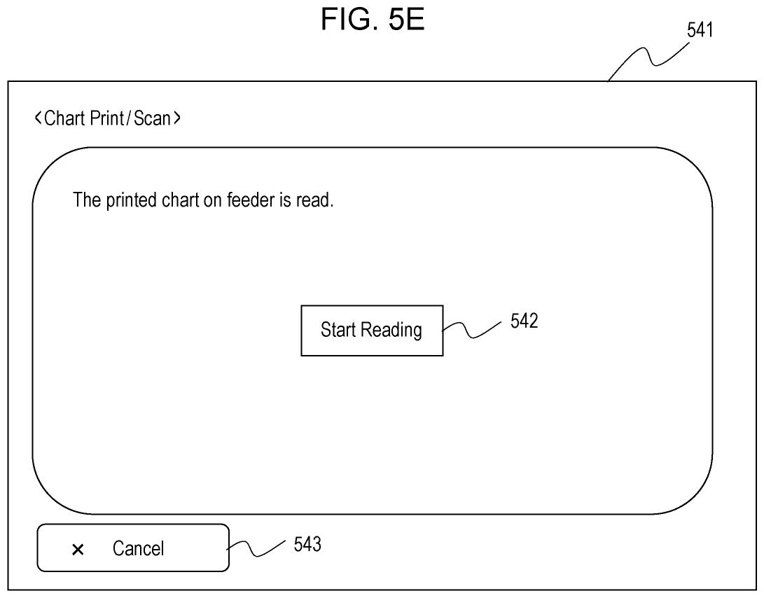

An example of a technique of registering a user define sheet is described with reference to FIGS. 5A to 5E.

Screens 501, 511, 521, 531, and 541 illustrated in FIGS. 5A to 5E are schematic examples of screens displayed in the instruction/display unit 140. According to the present embodiment, a user define sheet is the type of paper that is uniquely set by a user. The user can set the print control parameters for a user define sheet. The print control parameters are control parameters for forming an image on the paper. Example of print control parameters include the feature value of the paper, the temperature of the fixing heater 234d, the adjustment value of the secondary transfer voltage, and the adjustment value of the image position in the paper. Examples of the feature value of paper include the basis weight and the surface property. According to the present embodiment, as described below, a case is described in which a user define sheet is registered on the basis of the print control parameters for basic paper that are prepared in advance. The print control parameters for basic paper are stored in the paper type database, and the print control parameters for the user define sheet are added to the paper type database. The paper type database may be stored in a storage medium inside the image forming apparatus 100 or may be managed outside the image forming apparatus 100.

For example, the paper type database stores the type of paper, the feature value of the paper, and the print control parameters of the paper associated with one another. According to the present embodiment, a case is described in which, for example, the paper type database is stored in the RAM 130.

FIGS. 5A and 5B illustrate examples of the paper type selection screens 501 and 511. The paper type selection screens 501 and 511 are displayed on the instruction/display unit 140 on the basis of, for example, the user's selection operation on a menu screen.

The user can select one of three types of paper: basic paper, user define sheet, and all paper, by the pull-down menu 502 in the paper type selection screens 501 and 511 illustrated in FIGS. 5A and 5B. The CPU 110 reads the paper information in the paper type database stored in the RAM 130 in response to the user's selection and displays the paper information in a paper type list 503. In FIGS. 5A and 5B, as an example, the basic paper and the user define sheet are selected, respectively, using a pull-down menu 502, and an illustration in which all paper is selected is omitted. If all paper is selected, the information regarding both basic paper and user define sheet is displayed in the paper type list 503.

The paper type selection screen 501 illustrated in FIG. 5A is an example of the paper type selection screen that is displayed when basic paper is selected using the pull-down menu 502. The paper type list 503 displays a list of basic paper that can be selected when the user sets a user define sheet. The CPU 110 reads the information regarding the basic paper registered in the paper type database and displays the information in the paper type list 503. By selecting any one of the basic paper types from the paper types displayed in the paper type list 503 and pressing a Duplicate button 505, the user can register a new user define sheet in the paper type database on the basis of the information registered in the paper type database for the basic paper. The new user define sheet is given a new name. Registration of the information regarding a new user define sheet by pressing the Duplicate button 505 is performed in the same manner as described in, for example, Japanese Patent Laid-Open No. 2022-26815, and a detailed description is omitted here.

The user can select any one of the basic paper types from the paper types displayed in the paper type list 503 and then press a Details/Edit button 504. Thus, the user can confirm the details of the basic paper type.

The feature value of the basic paper include, for example, the basis weight and the size. According to the present embodiment, it is assumed that the feature value of the basic paper cannot be changed. Therefore, even if the user selects any one of the basic paper types from the paper types displayed in the paper type list 503 and then presses the Details/Edit button 504, the feature value (the print control parameter) of the basic paper cannot be changed. In addition, according to the present embodiment, the basic paper cannot be deleted. Therefore, when Basic Paper is selected using the pull-down menu 502, a Delete button 506 is grayed out to prevent the user from pressing the button. When an OK button 507 is pressed, the CPU 110 terminates the display of the paper type selection screen 501.

The paper type selection screen 511 illustrated in FIG. 5B is an example of a paper type selection screen that is displayed when User Define Sheet is selected using the pull-down menu 512. The paper type list 513 displays a list of user define sheets, and the CPU 110 reads the information regarding the user define sheets registered in the paper type database and displays the information in the paper type list 513. The user can select any one of the user define sheets displayed in the paper type list 513 and then press a Details/Edit button 514 to confirm the details of the user define sheet already registered in the paper type database. In addition, the user can select any one of the user define sheets displayed in the paper type list 513 and then press the Details/Edit button 514 and, thus, can change the feature value (the print control parameter) of the user define sheet registered in the paper type database. The feature value of a user define sheet includes, for example, the basis weight and the size.

Furthermore, the user can select any one of the user define sheets displayed in the paper type list 513 and then press a Duplicate button 515 and, thus, can register a new user define sheet on the basis of the user define sheet already registered in the paper type database. As described above, registration of new user define sheet information by pressing the Duplicate button 515 is performed in the same manner as described in, for example, Japanese Patent Laid-Open No. 2022-26815, and a detailed description of the registration is omitted. In addition, the user can select any one of the user define sheets displayed in the paper type list 513 and then press a Delete button 516 and, thus, can delete the selected user define sheet from the paper type database. When an OK button 517 is pressed, the CPU 110 terminates the display of the paper type selection screen 511.

FIGS. 5C to 5E illustrate examples of screens displayed after the operation performed on the paper type selection screen 501 or 511 is completed. When the Details/Edit buttons 504 and 514 of the paper type selection screens 501 and 511 are pressed, the CPU 110 changes the screen displayed by the instruction/display unit 140 from the paper type selection screens 501 and 511 illustrated in FIGS. 5A and 5B to the details/edit screen 521 illustrated in FIG. 5C, respectively. The details/edit screen 521 enables the user to confirm and edit the print control parameter settings necessary to control a variety of types of paper. As described above, according to the present embodiment, a case is described in which the feature value (the print control parameter) cannot be changed for the basic paper. In this case, the print control parameters cannot be edited (changed) on the details/edit screen 521 that is displayed when the Details/Edit button 504 of the paper type selection screen 501 illustrated in FIG. 5A is pressed. For example, the Change buttons 522a to 522e are grayed out so as not to be pressed.

In the details/edit screen 521, the name of the basic paper or user define sheet is displayed in a name field. The name of the basic paper is a name that is preregistered in the image forming apparatus 100. In contrast, the name of the user define sheet is a name registered by the user. One of “Basic Paper” and “User Define Sheet” is displayed in a type field. The weight of the paper is displayed in a basis weight field. The size of the paper is displayed in the size field. In a surface property field, the type indicating the surface shape characteristics of the paper is displayed. In an “adjustment of secondary transfer voltage” field and an “adjustment of image position” field, either “Not set” or “Set” is displayed. Examples of an adjustment value of the secondary transfer voltage and an image position are described below.

### Description of Adjustment Value

The secondary transfer voltage is a voltage applied to the secondary transfer roller 237. For example, the secondary transfer voltage is set to a value that is required to transfer the toner on the transfer belt 233c to the paper P and that prevents abnormal electrical discharge from occurring. For example, if paper P of a type having moisture content or a resistance value that differs significantly from the standard value is used for printing, the default value of the secondary transfer voltage may not provide optimal transfer. For example, if the resistance value of the paper P used for printing is higher than the standard value, the default value may be insufficient for the secondary transfer voltage. For this reason, it is necessary to apply a larger value of the secondary transfer voltage than the default value to the secondary transfer roller 237. In addition, if the moisture content of the paper P used for printing is lower than the standard value, abnormal electrical discharge is likely to occur and, thus, an image defect caused by abnormal electrical discharge may occur. Therefore, it is necessary to apply a smaller value of a secondary transfer voltage than the default value to the secondary transfer roller 237. As described above, it is necessary to control the secondary transfer voltage to an appropriate value in accordance with the type of paper P used for printing. Therefore, the image forming apparatus 100 prints an adjustment chart (not illustrated) on the paper P to register an appropriate adjustment value in accordance with the type of paper as the adjustment value of the secondary transfer voltage. Thereafter, the adjustment chart printed on the paper P is read by the image reading unit 170. The CPU 110 determines the adjustment value of the secondary transfer voltage on the basis of the adjustment chart read by the image reading unit 170 so that the transfer efficiency falls within the specified range.

When the user wants to newly register or reregister the adjustment of the secondary transfer voltage, the user presses a Change button 522d that is one of Change buttons 522a to 522e and that corresponds to the adjustment of the secondary transfer voltage. The CPU 110 then changes the screen displayed by the instruction/display unit 140 from the details/edit screen 521 illustrated in FIG. 5C to the chart print screen 531 illustrated in FIG. 5D. When a Start Printing button 532 is pressed on the chart print screen 531, the CPU 110 causes the adjustment chart to be printed on the paper P and, thereafter, causes the instruction/display unit 140 to display the chart reading screen 541 illustrated in FIG. 5E. The user places the adjustment chart printed on the paper P on a feeder of the image reading unit 170 and presses a Start Reading button 542. When the Start Reading button 542 is pressed, the CPU 110 instructs the image reading unit 170 to scan the paper P placed on the feeder. The CPU 110 calculates the adjustment value of the secondary transfer voltage on the basis of the adjustment chart read by the image reading unit 170.

The CPU 110 registers, in the paper type database, the calculated adjustment value of the secondary transfer voltage as the secondary transfer voltage for the paper selected from the paper type lists 503 and 513 displayed on the paper type selection screens 501 and 511, respectively, in association with the paper. After the adjustment value of the secondary transfer voltage for the paper is registered in the paper type database in this manner, “Set” is displayed in the “adjustment of secondary transfer voltage” field for the paper on the details/edit screen 521.

When an OK button 524 is pressed on the details/edit screen 521 illustrated in FIG. 5C, the CPU 110 returns the screen displayed by the instruction/display unit 140 from the details/edit screen 521 to the paper type selection screen 501 or 511, for example. If a Cancel button 533 is pressed on the chart print screen 531 illustrated in FIG. 5D, the CPU 110 returns the screen displayed by the instruction/display unit 140 from the chart print screen 531 to the details/edit screen 521, for example. If a Cancel button 543 is pressed on the chart reading screen 541 illustrated in FIG. 5E, the CPU 110 returns the screen displayed by the instruction/display unit 140 from the chart reading screen 541 to the details/edit screen 521, for example.

In this case, the CPU 110 may return the screen displayed by the instruction/display unit 140 from the chart reading screen 541 to the chart print screen 531, for example.

Adjustment of the image position is performed to adjust the positions of the images printed on the front side and the back side of the paper P. The sliding condition for the rolls provided in the image forming unit 230 and the shrinkage condition for the paper P after image formation vary in accordance with the type of paper P. For this reason, adjustment values for the image position with respect to the reference position of the paper P (that is, adjustment values for the coordinate values of the image in a relative coordinate system with the reference position of the paper P being the origin) are set for the front side and the back side of the paper P. The reference position of paper P is, for example, the upper left corner. The image forming apparatus 100 prints an adjustment chart (not illustrated) on each of the front side and the back side of the paper P to register appropriate adjustment values for the paper. Thereafter, the adjustment charts printed on the paper P are read by the image reading unit 170. The CPU 110 calculates adjustment values for the image position on the basis of the adjustment charts read by the image reading unit 170. For example, the CPU 110 calculates the adjustment value of the image position on the basis of the difference between the position of the adjustment chart printed on the paper P (an aim position) and the position of the adjustment chart read by the image reading unit 170 (the actual position). The above-described adjustment chart for adjusting the secondary transfer voltage and the adjustment chart for adjusting the image position may be the same image or may be different images depending on the adjustment target.

When the user wants to newly register or reregister the adjustment of image position, the user presses the Change button 522e corresponding to the adjustment of image position among the Change buttons 522a to 522e. Then, like the adjustment of secondary transfer voltage, the chart print screen 531 is displayed, the Start Printing button 532 is pressed, the adjustment chart is printed, the chart reading screen 541 is displayed, the Start Reading button 542 is pressed, and the adjustment chart is read. The CPU 110 calculates the adjustment value of the image position on the basis of the adjustment chart read by the image reading unit 170. The CPU 110 registers, in the paper type database, the calculated adjustment value of the image position as the image position for the paper selected from the paper type lists 503 and 513 displayed on the paper type selection screens 501 and 511, respectively, in association with the paper. After the adjustment value of the image position for the paper is registered in the paper type database in this manner, “Set” is displayed in the “adjustment of image position” field for the paper on the details/edit screen 521.

In FIG. 5C, a case is illustrated in which the details/edit screen 521 displays the name, type, basis weight, size, surface property, adjustment of secondary transfer voltage, and adjustment of image position. However, various other parameters including print control parameters are registered in the paper type database. The user can confirm those parameters and register the parameters in the paper type database by pressing a button 523.

The case has been described above in which the user manually registers a user define sheet and sets (changes) print control parameters by pressing the Duplicate button 505 or 515 or the Details/Edit button 504 or 514. According to the present embodiment, in addition to such manual setting of print control parameters, a case is described in which the CPU 110 determines the type of the paper using the media sensor 270 and sets the print control parameters for the paper on the basis of the determined type of paper. Thus, the user is no longer aware of the paper type during the operation to register a user define sheet. Furthermore, according to the present embodiment, the feature value of the paper P is detected by the media sensor 270 when an adjustment chart is printed. This can reduce the wastage of paper P caused by outputting a blank sheet of paper when the media sensor 270 detects the feature value of the paper P. Still furthermore, as the print control parameters, the adjustment value can be set on the basis of the adjustment chart, and the feature value can be set on the basis of the output value of the media sensor 270 through a series of operations, that is, printing an adjustment chart and optically reading the adjustment chart. An example of the technique is described below.

### Registration of User Define Sheet

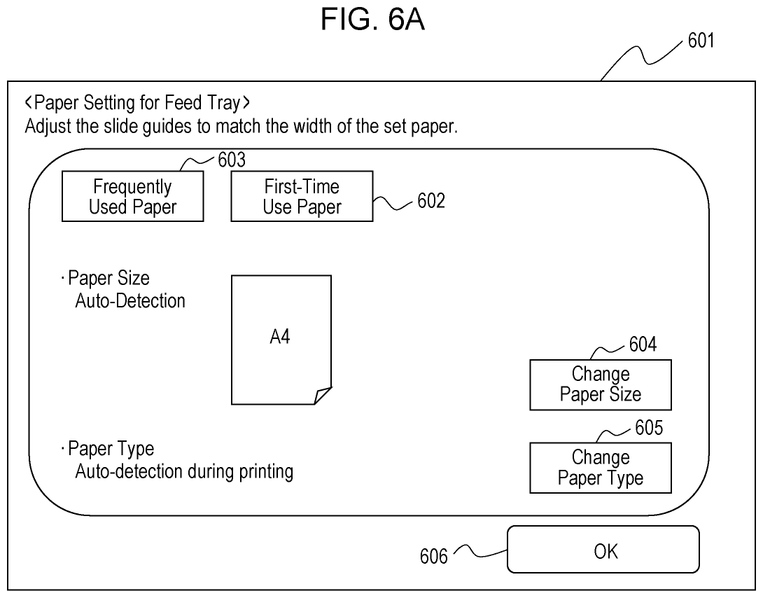

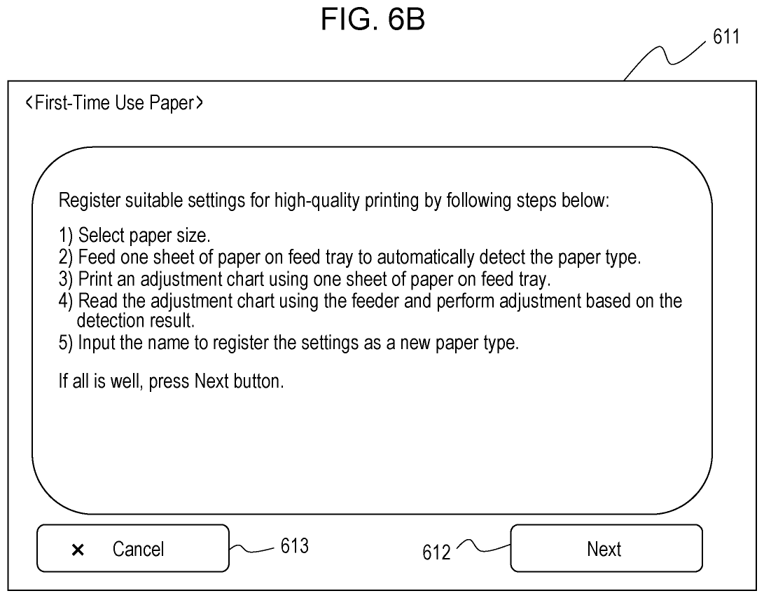

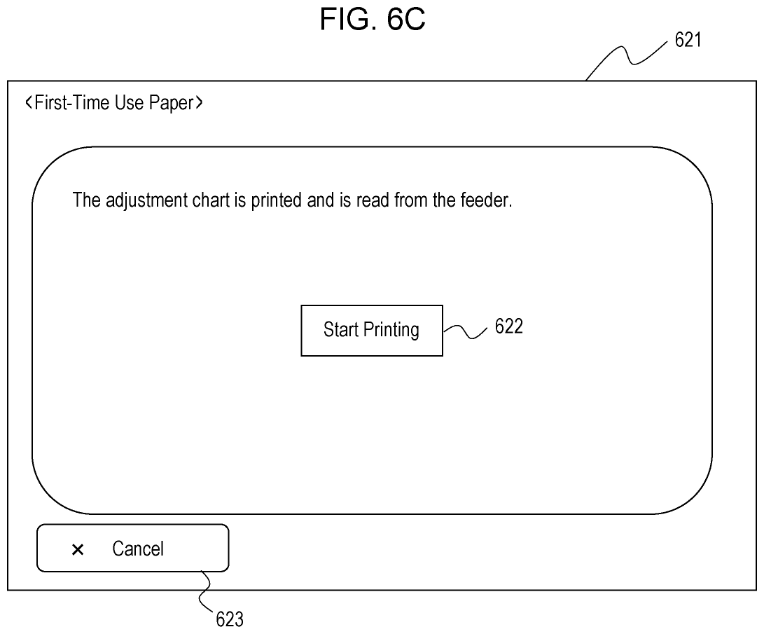

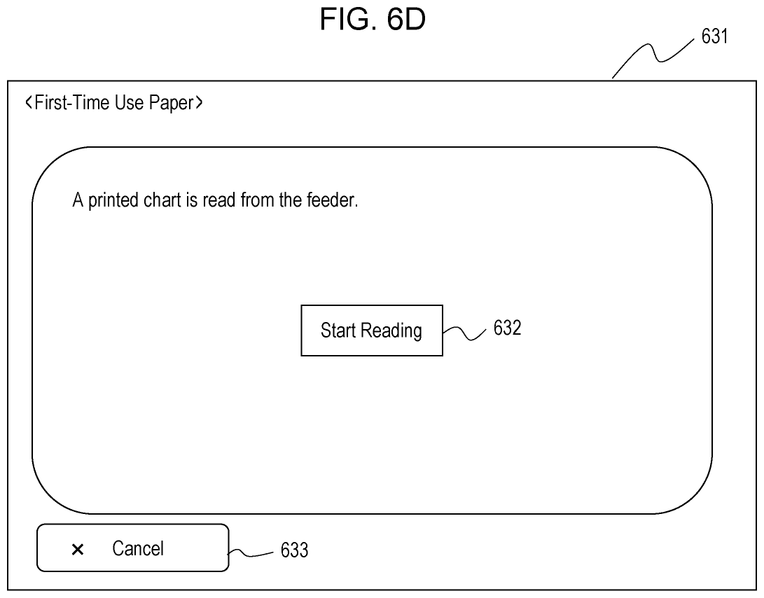

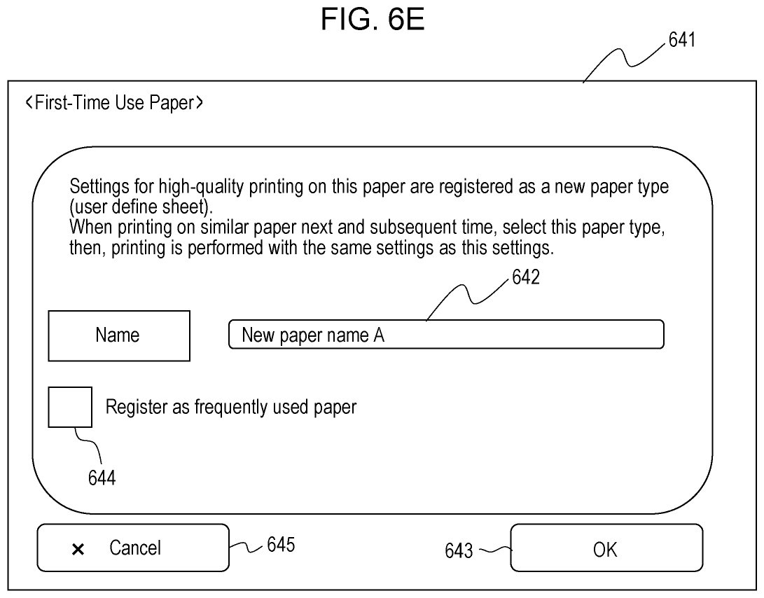

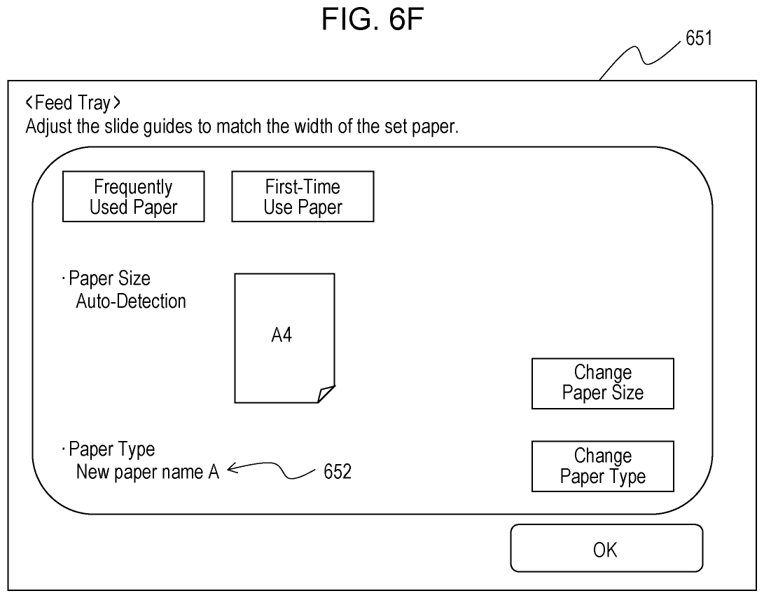

FIGS. 6A to 6F illustrate examples of screens for registering a user define sheet without the user being aware of the paper type. For example, a paper setting screen 601 illustrated in FIG. 6A is displayed on the instruction/display unit 140 when the CPU 110 determines that the paper P is placed on the manual feed tray 221. For example, a sensor (not illustrated) provided in the manual feed tray 221 detects that the paper P is placed on the manual feed tray 221.

In the description below, for example, the paper P is placed on the manual feed tray 221. However, the paper setting screen 601 may be displayed when the paper P placed in the feed cassette 211 is set as a user define sheet. In this case, for example, the paper setting screen 601 is provided for each of the feed cassettes 211. In addition, for example, the paper setting screen 601 is displayed on the instruction/display unit 140 when the paper setting screen 601 is invoked by an user operation, not by the event that the paper P is placed in the feed cassette 211. For example, the paper setting screen 601 is invoked through a selection operation on the menu screen.

The paper setting screen 601 enables the user to set the size, type, or the like of the paper P placed on the manual feed tray 221.

A “First-Time Use Paper” button 602 is a button that is pressed when a user define sheet is registered. A “Frequently Used Paper” button 603 is a button that is pressed when, among existing user define sheets, a user define sheet preregistered by the user is printed. When the “Frequently Used Paper” button 603 is pressed, the CPU 110 causes the instruction/display unit 140 to display a screen for selecting the paper to be printed (not illustrated). Printing is performed on the paper selected on the screen on the basis of the print control parameters registered in the paper type database. The basic paper may also be selectable on the screen. A “Change Paper Size” button 604 is pressed to select the size of the paper P. When the “Change Paper Size” button 604 is pressed, the CPU 110 causes the instruction/display unit 140 to display a screen (not illustrated) for selecting the size of the paper P. In addition to the sizes defined by the standard, a user-defined size can be selected on the screen. A “Change Paper Type” button 605 is a button that is pressed when the type of paper P is selected. When the “Change Paper Type” button 605 is pressed, the CPU 110 causes the instruction/display unit 140 to display a screen (not illustrated) for selecting the type of paper P. On the screen, the user can select to use the media sensor 270 to determine the type of paper. By allowing the user to select to use the media sensor 270 to determine the type of paper in addition to selecting the type of paper displayed on the screen, the above-described media auto-setting mode or media manual setting mode is set. When an OK button 606 is pressed, the CPU 110 terminates the display of the paper setting screen 601.

When the “First-Time Use Paper” button 602 is pressed, the CPU 110 changes the screen displayed by the instruction/display unit 140 from the paper setting screen 601 illustrated in FIG. 6A to an operation guide screen 611 illustrated in FIG. 6B. The operation guide screen 611 displays a guide of the operations required to register a user define sheet. If a Cancel button 613 is pressed on the operation guide screen 611, the CPU 110 returns the screen displayed by the instruction/display unit 140 from the operation guide screen 611 to the paper setting screen 601.

To continue the registration of the user define sheet, the user presses a Next button 612. Then, the CPU 110 changes the screen displayed by the instruction/display unit 140 from the operation guide screen 611 illustrated in FIG. 6B to a print instruction screen 621 illustrated in FIG. 6C. If a Cancel button 623 is pressed on the print instruction screen 621, the CPU 110 returns the screen displayed by the instruction/display unit 140 from the print instruction screen 621 to the paper setting screen 601.

The CPU 110 may return the screen displayed by the instruction/display unit 140 from the print instruction screen 621 to the operation guide screen 611.

To print the adjustment chart on the paper P placed on the manual feed tray 221, the user presses a Start Printing button 622. The CPU 110 then instructs the printer engine 160 to print the adjustment chart to be used for various adjustments on the paper P placed on the manual feed tray 221. In addition, the CPU 110 causes the media sensor 270 to detect the feature value of the paper P at the time of feeding of a first sheet of the paper P on which the adjustment chart is to be printed and, thus, determines the type of the paper P on the basis of the feature value.

Thereafter, the CPU 110 duplicates the determined paper type in the paper type database to create a duplicated paper type in the paper type database as the information regarding the paper P (a user define sheet) placed on the manual feed tray 221. At this time, the CPU 110 registers print control parameters that can be identified on the basis of the output value of the media sensor 270 (for example, the basis weight and the surface property) in the paper type database as the print control parameters for the paper P placed on the manual feed tray 221.

According to the present embodiment, a case is described in which the CPU 110 instructs the printer engine 160 to print the adjustment chart on the basis of the print control parameters identified on the basis of the output value of the media sensor 270. For example, suppose that when duplex printing is instructed to be performed, the basis weight and the surface property identified on the basis of the output value of the media sensor 270 are a basis weight and a surface property that do not enable duplex printing. In this case, the CPU 110 changes the printing of the adjustment chart from duplex printing to simplex printing. In addition, suppose that when printing of an adjustment chart for an automatic document feeder (ADF) is specified, the basis weight and the surface property identified on the basis of the output value of the media sensor 270 are a basis weight and a surface property that do not enable the ADF to scan the paper P. In this case, the CPU 110 changes the adjustment chart to be printed from the adjustment chart for an ADF to an adjustment chart for a pressure plate. In this manner, it is desirable that the CPU 110 instruct the printer engine 160 to print the adjustment chart based on the print control parameters identified on the basis of the output value of the media sensor 270.

After the adjustment chart is printed on the paper P as described above, the CPU 110 changes the screen displayed by the instruction/display unit 140 from the print instruction screen 621 illustrated in FIG. 6C to a reading instruction screen 631 illustrated in FIG. 6D. If a Cancel button 633 is pressed on the reading instruction screen 631, the CPU 110 returns the screen displayed by the instruction/display unit 140 from the reading instruction screen 631 to the paper setting screen 601. The CPU 110 may return the screen displayed by the instruction/display unit 140 from the reading instruction screen 631 to the operation guide screen 611 or the print instruction screen 621.

To start reading an adjustment chart printed on the paper P using the image reading unit 170, the user presses a Start Reading button 632 after setting the paper P on the image reading unit 170. The CPU 110 then instructs the image reading unit 170 to read the information on the paper P. The image reading unit 170 scans the paper P and optically reads the adjustment chart printed on the paper P.

The CPU 110 calculates the adjustment values of the print control parameters that can be calculated from an adjustment chart on the basis of the adjustment chart read by the image reading unit 170. Examples of the adjustment performed at this time is adjustment of the secondary transfer voltage and adjustment of the image position. However, the adjustment performed at this time is not limited to the adjustment of the secondary transfer voltage and adjustment of the image position, as long as the adjustment needs to be performed in association with the paper P. For example, the adjustment performed at this time may be adjustment of the target temperature of the fixing heater 234d and adjustment of the image forming speed. The printing and reading of the adjustment chart may be performed for a plurality of print control parameters in a single instance or in different instances. In the former case, the CPU 110 calculates the adjustment values for a plurality of print control parameters from a single adjustment chart. In the latter case, the CPU 110 calculates the adjustment value of a print control parameter from an adjustment chart on a one-to-one basis. The CPU 110 registers the adjustment value calculated as described above in the paper type database as a print control parameter for the user define sheet (the paper P placed on the manual feed tray 221 to print the adjustment chart) newly registered in the paper type database.

Subsequently, the CPU 110 changes the screen displayed by the instruction/display unit 140 from the reading instruction screen 631 illustrated in FIG. 6D to a name input screen 641 illustrated in FIG. 6E. If a Cancel button 645 on the name input screen 641 is pressed, the CPU 110 returns the screen displayed by the instruction/display unit 140 from the name input screen 641 to the paper setting screen 601.

The CPU 110 may return the screen displayed by the instruction/display unit 140 from the name input screen 641 to any one of the operation guide screen 611, the print instruction screen 621, and the reading instruction screen 631.

The user inputs any name to a name entry field 642 and, then, presses an OK button 643. At this time, if the user define sheet newly registered in the paper type database is set as frequently used paper, the user checks a checkbox 644 and then presses the OK button 643. As a result, when the “frequently used paper” button 603 illustrated in FIG. 6A is pressed, the user define sheet newly registered in the paper type database appears in the paper options to be printed.

When the OK button 643 is pressed, the CPU 110 changes the screen displayed by the instruction/display unit 140 to a paper setting screen 651 illustrated in FIG. 6F. The paper setting screen 651 has the same role as the paper setting screen 601 illustrated in FIG. 6A. However, on the paper setting screen 651 illustrated in FIG. 6F, the name input to the name entry field 642 illustrated in FIG. 6E is displayed in a paper type field 652, and the user define sheet is registered in the paper type database as described above. Thereafter, the user presses, for example, the “Frequently Used Paper” button 603 to print the same type of paper as the user define sheet. The user then selects the user define sheet on a screen (not illustrated) that is displayed when pressing the “Frequently used button” 603. As a result, printing using the print control parameters registered in the paper type database is performed on the user define sheet.

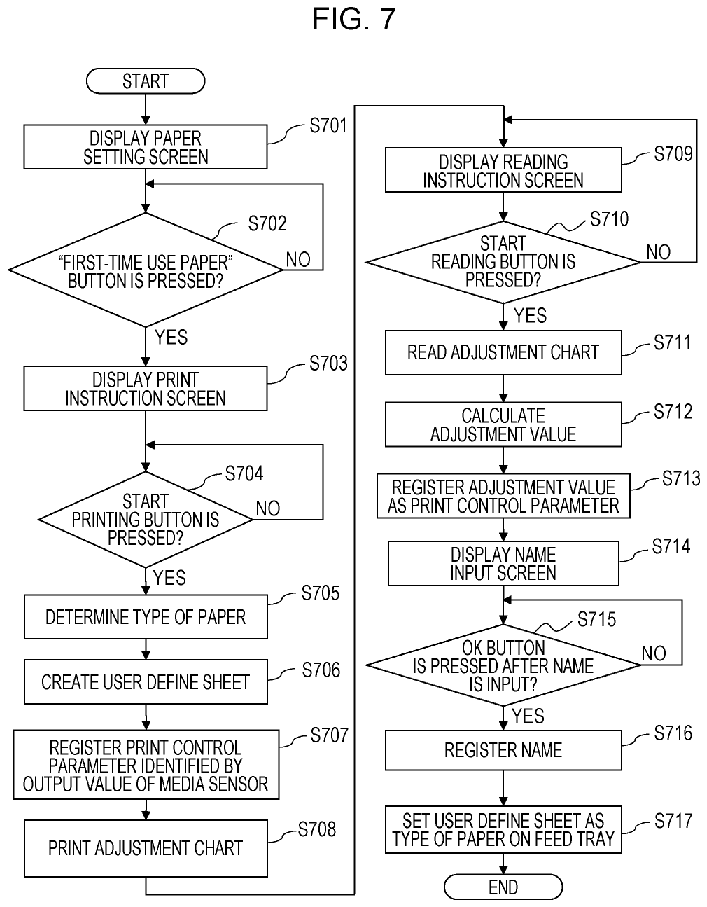

An example of screen transition that occurs when a user define sheet is registered has been described above. An example of the flow of control performed when a user define sheet is registered is described below with reference to the flowchart illustrated in FIG. 7. Each of steps of the flowchart illustrated in FIG. 7 is performed by, for example, the CPU 110 that loads a control program from the ROM 120 onto the RAM 130 and executes the program.

A case is described below in which the flowchart illustrated in FIG. 7 starts when the CPU 110 determines that the paper P is placed on the manual feed tray 221.

In S701, the CPU 110 causes the instruction/display unit 140 to display the paper setting screen 601.

In S702, the CPU 110 waits until the “First-Time Use Paper” button 602 is pressed. When the “First-Time Use Paper” button 602 is pressed (Yes in S702), the process in S703 is performed. In S703, the CPU 110 causes the instruction/display unit 140 to display the operation guide screen 611 and, thereafter, causes the instruction/display unit 140 to display the print instruction screen 621. The screen transition from the operation guide screen 611 to the print instruction screen 621 is performed when the Next button 612 is pressed on the operation guide screen 611.

In S704, the CPU 110 waits until the Start Printing button 622 is pressed. When the Start Printing button 622 is pressed (Yes in S704), the process in S705 is performed. In S705, the CPU 110 instructs the printer engine 160 to feed the paper P from the manual feed tray 221 and instructs the media sensor 270 to detect the feature value of the paper P. The CPU 110 then determines the type of paper P on the basis of the output value of the media sensor 270.

In S706, the CPU 110 duplicates the paper type identified in S705 into the paper type database to create information regarding the user define sheet in the paper type database. In S707, the CPU 110 registers the print control parameters identified on the basis of the output value of the media sensor 270 as the print control parameters for the user define sheet created in S706.

In S708, the CPU 110 instructs the printer engine 160 to print an adjustment chart on the basis of the print control parameters for the user define sheet registered in S707.

In S709, the CPU 110 causes the instruction/display unit 140 to display the reading instruction screen 631.

In S710, the CPU 110 determines whether the Start Reading button 632 is pressed. As a result of the determination, if the Start Reading button 632 is not pressed (No in S710), the process in S709 is performed again. However, if the Start Reading button 632 is pressed (Yes in S710), the process in S711 is performed. In S711, the CPU 110 instructs the image reading unit 170 to read the information on the paper. As a result, the image reading unit 170 scans the paper to optically read the adjustment chart printed on the paper.

In S712, the CPU 110 calculates the adjustment values of the print control parameters for the paper on the basis of the scanned image of the adjustment chart. In S713, the CPU 110 registers the adjustment value calculated in S712 as a print control parameter of the user define sheet created in S706.

In S714, the CPU 110 causes the instruction/display unit 140 to display the name input screen 641. In S715, the CPU 110 waits until a name is input in the name entry field 642 and, thereafter, the OK button 643 is pressed. When a name is input to the name entry field 642 and, thereafter, the OK button 643 is pressed (Yes in S715), the process in S716 is performed.

In S716, the CPU 110 registers the name input to the name entry field 642 as the name of the user define sheet created in S706. In S717, the CPU 110 sets the user define sheet registered in the paper type database through the processes performed in S701 to S715 as the type of paper fed from the manual feed tray 221. In addition, the CPU 110 displays, in the paper type field 652 of the paper setting screen 651 illustrated in FIG. 6F, the name input to the name entry field 642. When the processing in S717 is completed, the processing according to the flowchart illustrated in FIG. 7 ends.

### SUMMARY

As described above, according to the present embodiment, the image forming apparatus 100 detects, from the paper P, paper information, which is information reflecting the feature of the paper P. The image forming apparatus 100 then sets at least one of the print control parameters for the paper P as information to be registered in the paper database on the basis of the detected paper information. This saves the user the trouble of identifying the paper type and the feature that arises when the user manually sets each of the print control parameters. For example, the image forming apparatus 100 determines the type of the paper on the basis of the feature value of the paper (for example, the basis weight and the surface property) detected by the media sensor 270. The image forming apparatus 100 then sets the print control parameters for the paper on the basis of the determined paper type as information to be registered in the paper database. In addition, the image forming apparatus 100 sets the print control parameters for the paper having an adjustment chart printed thereon on the basis of the adjustment chart detected by the image reading unit 170 as information to be registered in the paper database. In this case, an example of information reflecting the feature of the paper P (paper information) is the feature value of the paper and the adjustment chart. To detect the paper information, first detection using the media sensor 270 and second detection using the image reading unit 170 are performed. In addition, the adjustment chart is printed as an example of the print information.

To determine the type of paper P using the media sensor 270 that detects the paper P being conveyed along the sheet conveying path R1, it is necessary to output the paper P. In this case, outputting a blank sheet of paper P results in wasteful consumption of paper. Even if, as described in Japanese Patent Laid-Open No. 2022-26815, the type of paper P determined using the media sensor 270 is defined as a user define sheet, it is troublesome for the user to change the print control parameters, because the user needs to take the time to input the feature value that can be measured by the media sensor 270. In contrast, according to the present embodiment, the image forming apparatus 100 detects the feature value of the paper P when printing the adjustment chart on the paper P, reads the adjustment chart from the paper P having the adjustment chart printed thereon, and calculates the adjustment value on the basis of the adjustment chart. Thus, there is no need to output a blank sheet of paper when the feature value of paper P is detected using the media sensor 270 and, therefore, wastage of paper can be avoided when the feature value of paper P is detected using the media sensor 270. Furthermore, by setting the adjustment value based on the adjustment chart and the feature value based on the output value of the media sensor 270 as the print control parameters, the user can reduce the time required to create and edit information regarding the user define sheet.

The disclosure of the present embodiment includes, for example, the configurations and method described below.

### Configuration 1

A processing device includes a detection unit configured to detect, from paper, paper information that reflects the feature of the paper and a setting unit configured to set at least one of print control parameters that are used to print on the paper as information to be registered in a paper database, based on the paper information detected by the detection unit.

### Configuration 2

In the processing device according to Configuration 1, the detection unit includes a first detection unit configured to detect the paper information from the paper after the paper is fed and before the paper is printed.

### Configuration 3

In the processing device according to Configuration 2, the setting unit identifies the type of the paper on the basis of the paper information detected by the first detection unit and sets at least one of the print control parameters for paper of the type.

### Configuration 4

In the processing device according to any one of Configurations 1 to 3, the detection unit includes a second detection unit configured to detect the paper information by optically reading print information printed on paper.

### Configuration 5

The processing device according to Configuration 4 further includes a printing unit, and the printing unit prints the print information on paper.

### Configuration 6

In the processing device according to any one of Configurations 1 to 5, the detection unit includes a first detection unit configured to detect the paper information from the paper after the paper is fed and before the paper is printed and a second detection unit configured to detect the paper information by optically reading print information printed on paper. The second detection unit detects, as the paper information, print information printed on the paper from which the paper information is detected by the first detection unit.

### Configuration 7

The processing device according to Configuration 6 further includes a printing unit, and the printing unit prints, on the paper, the print information based on the print control parameter set by the setting unit on the basis of the paper information detected by the first detection unit.

### Configuration 8

In the processing device according to any one of Configurations 1 to 7, the print control parameter is set for each of the types of paper, and the print control parameter set by the setting unit is a print control parameter used to print on paper of the same type as the paper having the paper information detected by the detection unit.

### Method 1

A processing method includes detecting, from paper, paper information that reflects the feature of the paper and setting, as information to be registered in a paper database, at least one of print control parameters that are used to print on the paper, on the basis of the detected paper information.

### Medium 1

A non-transitory computer-readable storage medium stores one or more control programs including executable instructions, which when executed by a computer, cause the computer to perform a processing method. The processing method includes detecting, from the paper, paper information that reflects the feature of the paper and setting, as information to be registered in a paper database, at least one of print control parameters that are used to print on the paper on the basis of the detected paper information.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-032854 filed Mar. 3, 2023, which is hereby incorporated by reference herein in its entirety.

What is claimed is:

1. A processing device comprising:
a detection unit configured to detect, from paper, paper information that reflects a feature of the paper; and
a setting unit configured to set at least one of a plurality of print control parameters that are used to print on the paper as information to be registered in a paper database, based on the paper information detected by the detection unit.

2. The processing device according to claim 1, wherein the detection unit includes a first detection unit configured to detect the paper information from the paper after the paper is fed and before the paper is printed.

3. The processing device according to claim 2, wherein the setting unit identifies a type of the paper based on the paper information detected by the first detection unit and sets at least one of the print control parameters for paper of the type.

4. The processing device according to claim 1, wherein the detection unit includes a second detection unit configured to detect the paper information by optically reading print information printed on the paper.

5. The processing device according to claim 4, further comprising:
a printing unit,
wherein the printing unit prints the print information on the paper.

6. The processing device according to claim 1, wherein the detection unit includes a first detection unit configured to detect the paper information from the paper after the paper is fed and before the paper is printed and
a second detection unit configured to detect the paper information by optically reading print information printed on the paper, and
wherein the second detection unit detects, as the paper information, print information printed on the paper from which the paper information is detected by the first detection unit.

7. The processing device according to claim 6, further comprising:
a printing unit,
wherein the printing unit prints, on the paper, the print information based on the print control parameter set by the setting unit based on the paper information detected by the first detection unit.

8. The processing device according to claim 1, wherein the print control parameter is set for each of the types of paper, and
wherein the print control parameter set by the setting unit is a print control parameter used to print on another paper of the same type as the paper having the paper information detected by the detection unit.

9. A processing method comprising:
detecting, from a paper, paper information that reflects a feature of the paper; and
setting, as information to be registered in a paper database, at least one of a plurality of print control parameters that are used to print on the paper, based on the detected paper information.

10. A non-transitory computer-readable storage medium storing one or more control programs including executable instructions, which when executed by a computer, cause the computer to perform a processing method comprising:
detecting paper information that reflects a feature of a paper from the paper; and
setting, as information to be registered in a paper database, at least one of a plurality of print control parameters that are used to print on the paper based on the detected paper information.
